(19) United States
(12) Patent Application Publication
(10) Pub. No.: US 2025/0055596 A1
(43) Pub. Date: Feb. 13, 2025

(54) CONTROL RESOURCE SET PUNCTURING

(71) Applicant: QUALCOMM Incorporated, San Diego, CA (US)

(72) Inventors: Le LIU, San Jose, CA (US); Alberto RICO ALVARINO, San Diego, CA (US); Jae Ho RYU, San Diego, CA (US); James BECKMAN, La Jolla, CA (US)

(21) Appl. No.: 18/542,463

(22) Filed: Dec. 15, 2023

Related U.S. Application Data
(60) Provisional application No. 63/518,042, filed on Aug. 7, 2023.

(51) Int. Cl. H04L 1/00; H04W 56/00; H04W 72/232

(52) U.S. Cl. CPC H04L 1/0069; H04L 1/0071; H04W 56/0015; H04W 72/232

(57) ABSTRACT

Various aspects of the present disclosure generally relate to wireless communication. In some aspects, a user equipment (UE) may receive signaling identifying a control resource set (CORESET) puncturing pattern, the CORESET puncturing pattern being based, at least in part, on a number of resource blocks available before and after a CORESET puncturing process and a number of symbols of the CORESET. The UE may decode downlink control information in accordance with the CORESET puncturing pattern. Numerous other aspects are described.

### CROSS-REFERENCE TO RELATED APPLICATION

This patent application claims priority to U.S. Provisional Patent Application No. 63/518,042, filed on Aug. 7, 2023, entitled “CONTROL RESOURCE SET PUNCTURING,” and assigned to the assignee hereof. The disclosure of the prior Application is considered part of and is incorporated by reference into this patent application.

### FIELD OF THE DISCLOSURE

Aspects of the present disclosure generally relate to wireless communication and to techniques and apparatuses for control resource set puncturing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks May support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be individually or collectively configured to receive signaling identifying a control resource set (CORESET) puncturing pattern, the CORESET puncturing pattern being based, at least in part, on a number of resource blocks available before and after a CORESET puncturing process and a number of symbols of the CORESET. The one or more processors may be individually or collectively configured to decode downlink control information in accordance with the CORESET puncturing pattern.

Some aspects described herein relate to a network node for wireless communication. The network node may include one or more memories and one or more processors coupled to the one or more memories. The one or more processors may be individually or collectively configured to output signaling identifying a CORESET puncturing pattern, the CORESET puncturing pattern being based, at least in part, on a number of resource blocks available before and after a CORESET puncturing process and a number of symbols of the CORESET. The one or more processors may be individually or collectively configured to configure a UE to decode downlink control information in accordance with the CORESET puncturing pattern.

Some aspects described herein relate to a method of wireless communication performed by a UE. The method may include receiving signaling identifying a CORESET puncturing pattern, the CORESET puncturing pattern being based, at least in part, on a number of resource blocks available before and after a CORESET puncturing process and a number of symbols of the CORESET. The method may include decoding downlink control information in accordance with the CORESET puncturing pattern.

Some aspects described herein relate to a method of wireless communication performed by a network node. The method may include outputting signaling identifying a CORESET puncturing pattern, the CORESET puncturing pattern being based, at least in part, on a number of resource blocks available before and after a CORESET puncturing process and a number of symbols of the CORESET. The method may include configuring a UE to decode downlink control information in accordance with the CORESET puncturing pattern.

Some aspects described herein relate to a non-transitory computer-readable medium that stores a set of instructions for wireless communication by a UE. The set of instructions, when individually or collectively executed by one or more processors of the UE, may cause the UE to receive signaling identifying a CORESET puncturing pattern, the CORESET puncturing pattern being based, at least in part, on a number of resource blocks available before and after a CORESET puncturing process and a number of symbols of the CORESET. The set of instructions, when executed by one or more processors of the UE, may cause the UE to decode downlink control information in accordance with the CORESET puncturing pattern.

Some aspects described herein relate to a non-transitory computer-readable medium that stores a set of instructions for wireless communication by a network node. The set of instructions, when individually or collectively executed by one or more processors of the network node, may cause the network node to output signaling identifying a CORESET puncturing pattern, the CORESET puncturing pattern being based, at least in part, on a number of resource blocks available before and after a CORESET puncturing process and a number of symbols of the CORESET. The set of instructions, when individually or collectively executed by one or more processors of the network node, may cause the network node to configure a UE to decode downlink control information in accordance with the CORESET puncturing pattern.

Some aspects described herein relate to an apparatus for wireless communication. The apparatus may include means for receiving signaling identifying a CORESET puncturing pattern, the CORESET puncturing pattern being based, at least in part, on a number of resource blocks available before and after a CORESET puncturing process and a number of symbols of the CORESET. The apparatus may include means for decoding downlink control information in accordance with the CORESET puncturing pattern.

Some aspects described herein relate to an apparatus for wireless communication. The apparatus may include means for outputting signaling identifying a CORESET puncturing pattern, the CORESET puncturing pattern being based, at least in part, on a number of resource blocks available before and after a CORESET puncturing process and a number of symbols of the CORESET. The apparatus may include means for configuring a UE to decode downlink control information in accordance with the CORESET puncturing pattern.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example resource structure for wireless communication, in accordance with the present disclosure.

FIG. 5 is a diagram illustrating an example associated with a control resource set (CORESET) puncturing pattern, in accordance with the present disclosure.

FIGS. 6-11 are diagrams illustrating examples associated with different CORESET puncturing patterns, in accordance with the present disclosure.

FIG. 12 is a diagram of an example associated with decoding downlink control information signals, in accordance with the present disclosure.

FIG. 13 is a diagram illustrating an example process performed, for example, at a UE or an apparatus of a UE, in accordance with the present disclosure.

FIG. 14 is a diagram illustrating an example process performed, for example, at a network node or an apparatus of a network node, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

A control resource set (CORESET) addresses challenges associated with managing and controlling data transmission on a diverse range of frequency bands. The CORESET is a predefined set of physical resource blocks (PRBs) within the frequency domain and slots in the time domain that are reserved for control channel transmission, including scheduling assignments, system control information, and other network instructions. CORESETs enable the network to communicate control signals to a user equipment (UE) in a consistent and structured manner while also providing a mechanism for scheduling transmissions dynamically on a per-UE basis. Moreover, the flexibility of the CORESET configuration contributes to more efficient spectrum utilization and improved capacity. Accordingly, CORESETs allow the network to maintain robust and reliable communications and optimize the user experience, particularly in high-demand wireless communication environments.

CORESET “puncturing” refers to a technique where the control signals, specifically transmitted through CORESETs, are intentionally left blank or “punctured” in certain circumstances to restrict the transmission within a limited bandwidth, or in other circumstances to allow for the transmission of other, potentially higher priority data. CORESET puncturing facilitates the allocation of resources in a dynamic and flexible way, where the specific requirements or demands of the network can be prioritized as needed. For example, if the network has limited transmission bandwidth in a carrier bandwidth, the CORESET could be designed to puncture a legacy CORESET of a minimum bandwidth to a CORESET with a limited transmission bandwidth, such as puncturing legacy minimum 24-resource block (RB) CORESET into a 15-RB CORESET within a 3 MHz channel bandwidth, or puncturing the legacy minimum 24-RB CORESET into a 20-RB CORESET within a 5 MHz channel bandwidth. For example, if a network is experiencing a high demand for data traffic, the CORESET could be punctured to make room for the transmission of additional data, effectively improving network efficiency and capacity. Excessive or inappropriate CORESET puncturing, however, can negatively impact network performance and quality of service since CORESETs carry control information used for network operation. Therefore, CORESET puncturing must be performed with care and diligence.

Various aspects relate generally to CORESET puncturing. Some aspects more specifically relate to CORESET puncturing patterns for certain bandwidths and/or numbers of PRBs. Some aspects more specifically relate to CORESET puncturing patterns for certain RBs offset relative a synchronization signal block (SSB). Some aspects further relate to control channel element (CCE)-to-resource element group (REG) mapping based, at least in part, on the CORESET puncturing. In some examples, a UE receives signaling identifying a CORESET puncturing pattern, the CORESET puncturing pattern being based, at least in part, on a number of resource blocks available before and after a CORESET puncturing process and a number of symbols of the CORESET; and decodes downlink control information (DCI) in accordance with the CORESET puncturing pattern. In some examples, a network node outputs signaling identifying a CORESET puncturing pattern, the CORESET puncturing pattern being based, at least in part, on a number of resource blocks available before and after a CORESET puncturing process and a number of symbols of the CORESET; and configures a UE to decode DCI in accordance with the CORESET puncturing pattern.

Particular aspects of the subject matter described in this disclosure can be implemented to realize one or more of the following potential advantages. In some examples, by receiving signaling identifying a CORESET puncturing pattern, the described techniques can be used to allow the UE to communicate in accordance with a CORESET puncturing pattern from a legacy CORESET (e.g., a legacy CORESET0) to a CORESET (e.g., CORESET0) transmitted in a limited bandwidth. For the CORESET0 indicated by a physical broadcast channel (PBCH)/master information block (MIB) for the UE to detect system information block (SIB) signaling, the legacy CORESET0 has minimum of 24 RBs transmitted in a 5 MHz channel bandwidth. In order to enable CORESET0 transmitted in less than 5 MHz within a 5 MHz channel bandwidth or even in a 3 MHz channel bandwidth, CORESET puncturing can be indicated to puncture from legacy 24-RB CORESET0 to a CORESET0 (e.g., 20-RB) with 3.6 MHz within a 5 MHz channel bandwidth, or to a CORESET0 (e.g., 15-RB) with 2.7 MHz in a 3 MHz channel bandwidth. In some examples, by receiving signaling identifying a CORESET puncturing pattern, the described techniques can be used to allow the UE to communicate in accordance with a CORESET puncturing pattern that improves network operation without significantly sacrificing quality of service. In some examples, by configuring a UE to decode downlink control information in accordance with the CORESET puncturing pattern, the described techniques can be used to communicate control information even in instances where high priority data must be transmitted.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

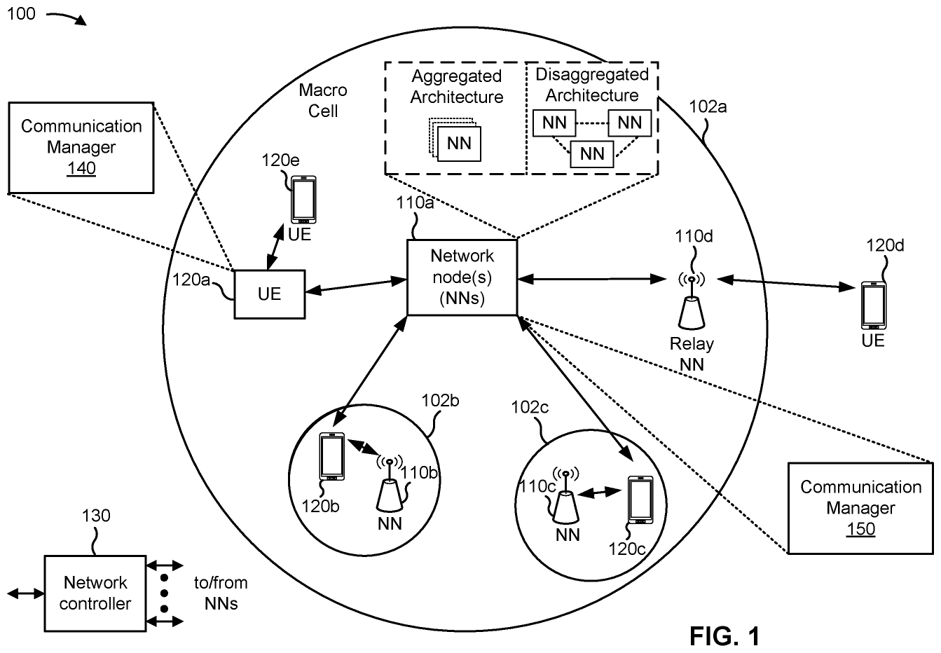

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive signaling identifying a CORESET puncturing pattern, the CORESET puncturing pattern being based, at least in part, on a number of resource blocks available before and after a CORESET puncturing process and a number of symbols of the CORESET; and decode downlink control information in accordance with the CORESET puncturing pattern. Additionally, or alternatively, the communication manager 140 may perform one or more other operations described herein.

In some aspects, the network node 110 may include a communication manager 150. As described in more detail elsewhere herein, the communication manager 150 may output signaling identifying a CORESET puncturing pattern, the CORESET puncturing pattern being based, at least in part, on a number of resource blocks available before and after a CORESET puncturing process and a number of symbols of the CORESET; and configure a UE to decode downlink control information in accordance with the CORESET puncturing pattern. Additionally, or alternatively, the communication manager 150 may perform one or more other operations described herein.

As indicated above, FIG. 1 is provided as an example. Other examples may differ from what is described with regard to FIG. 1.

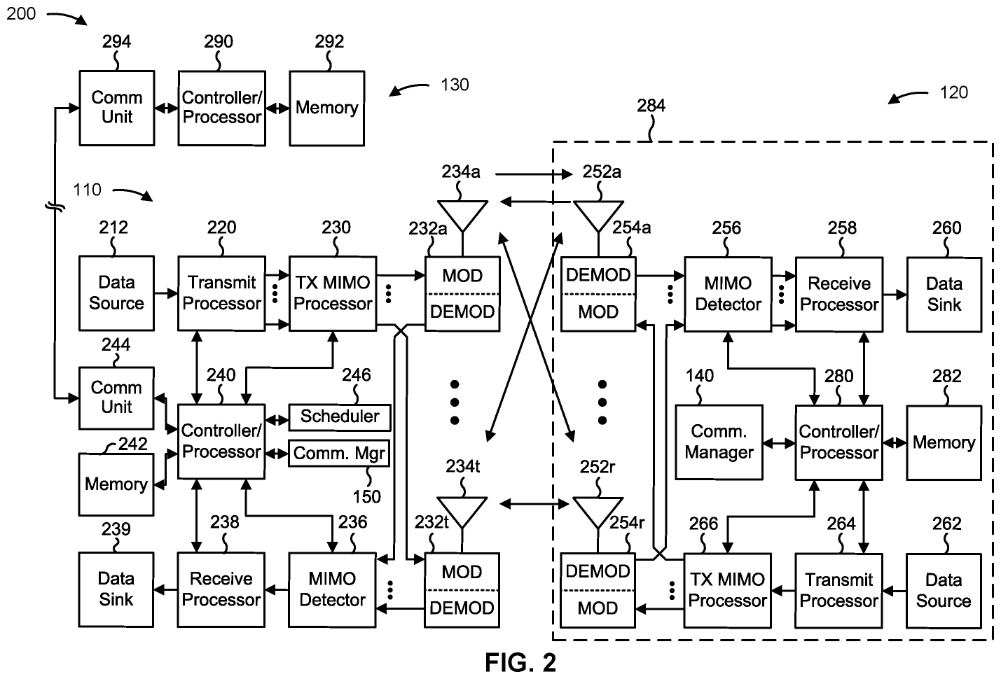

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

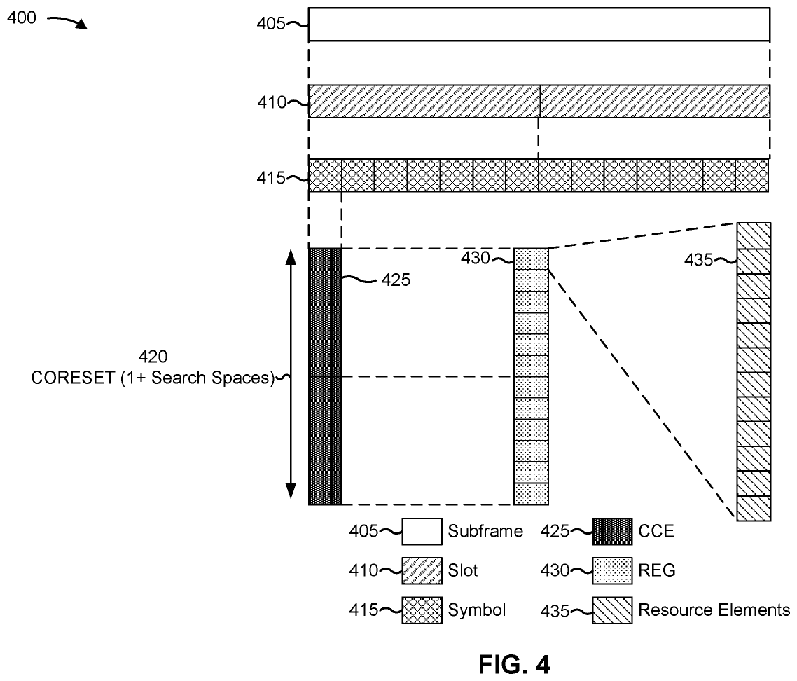

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-16).

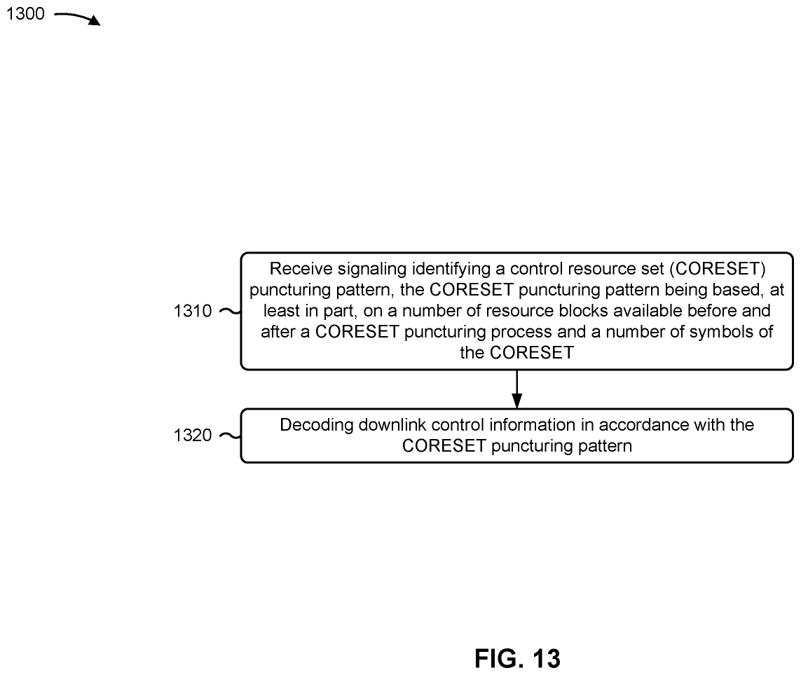

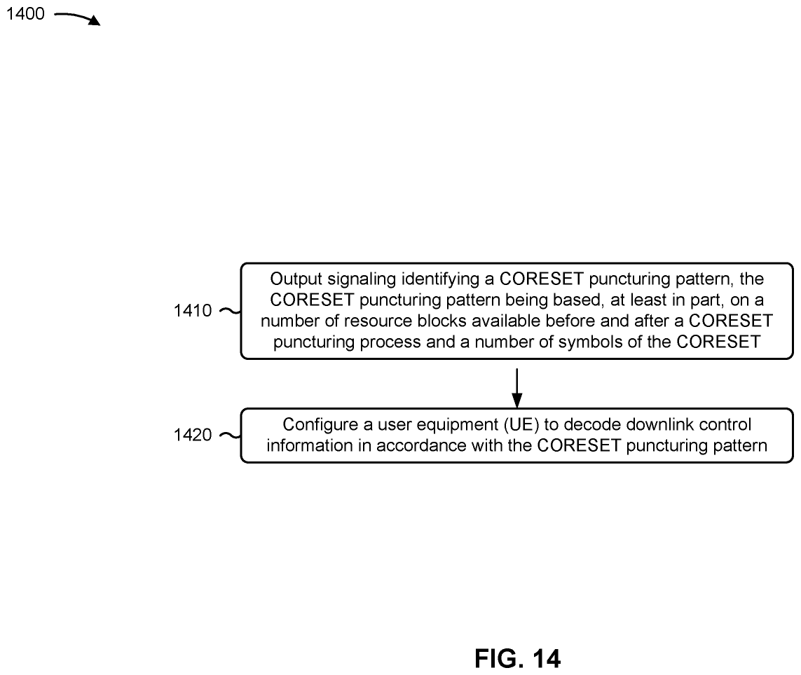

The controller/processor 240 of the network node 110, the controller/processor 280 of the UE 120, and/or any other component(s) of FIG. 2 may perform one or more techniques associated with CORESET puncturing, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for receiving signaling identifying a CORESET puncturing pattern, the CORESET puncturing pattern being based, at least in part, on a number of resource blocks available before and after a CORESET puncturing process and a number of symbols of the CORESET; and/or means for decoding downlink control information in accordance with the CORESET puncturing pattern. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for outputting signaling identifying a CORESET puncturing pattern, the CORESET puncturing pattern being based, at least in part, on a number of resource blocks available before and after a CORESET puncturing process and a number of symbols of the CORESET; and/or means for configuring a UE to decode downlink control information in accordance with the CORESET puncturing pattern. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

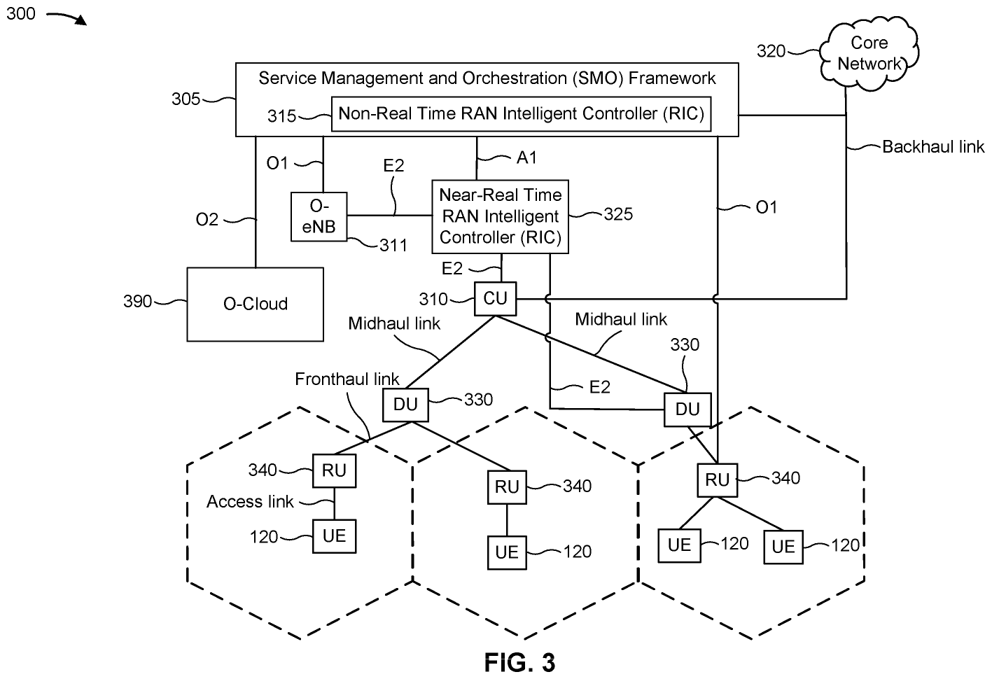

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a CORESET 420 and may be structured to support an efficient use of resources, such as by flexible configuration or reconfiguration of resources of the CORESET 420 for one or more physical downlink control channels (PDCCHs) and/or one or more physical downlink shared channels (PDSCHs). In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in the frequency domain, and either one, two, or three symbols 415 in the time domain. In 5G, a quantity of resources included in the CORESET 420 may be flexibly configured, such as by using radio resource control (RRC) signaling to indicate a frequency domain region (e.g., a quantity of resource blocks) and/or a time domain region (e.g., a quantity of symbols) for the CORESET 420.

As illustrated, a symbol 415 that includes CORESET 420 may include one or more CCEs 425, shown as two CCEs 425 as an example, that span a portion of the system bandwidth. A CCE 425 may include downlink control information (DCI) that is used to provide control information for wireless communication. A base station may transmit DCI during multiple CCEs 425 (as shown), where the quantity of CCEs 425 used for transmission of DCI represents the aggregation level (AL) used by the BS for the transmission of DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of REGs 430, shown as 6 REGs 430, or may include a variable quantity of REGs 430. In some aspects, the quantity of REGs 430 included in a CCE 425 may be specified by a REG bundle size. A REG 430 may include one resource block, which may include 12 resource elements (REs) 435 within a symbol 415. A resource element 435 may occupy one subcarrier in the frequency domain and one OFDM symbol in the time domain.

A search space may include all possible locations (e.g., in time and/or frequency) where a PDCCH may be located. A CORESET 420 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

As indicated above, FIG. 4 is provided as an example. Other examples may differ from what is described with respect to FIG. 4.

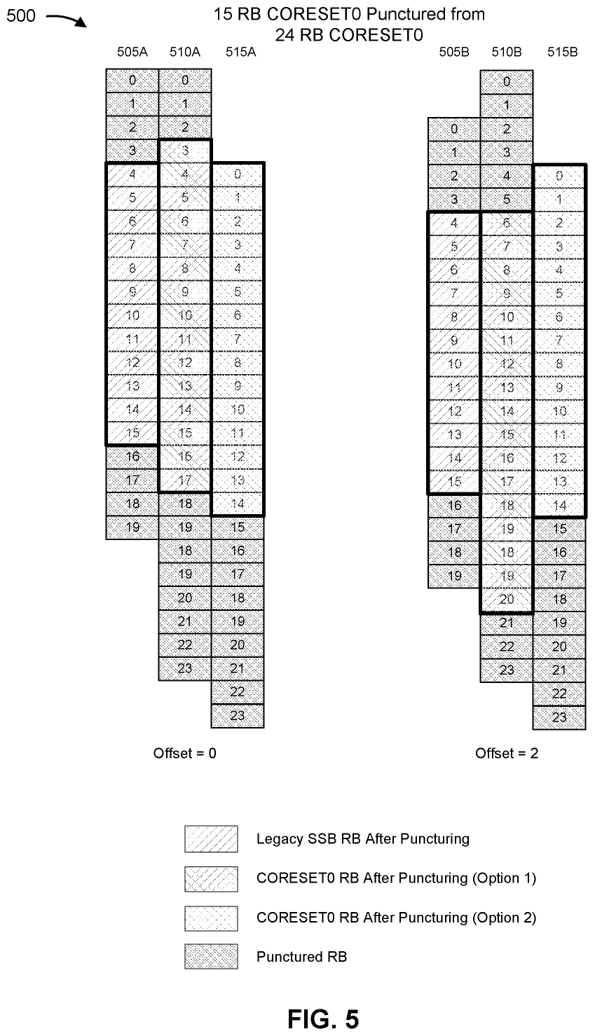

FIG. 5 is a diagram illustrating an example 500 associated with a CORESET puncturing pattern, in accordance with the present disclosure.

As shown in the example 500 of FIG. 5, for a 3 MHz channel bandwidth with maximum RF transmission bandwidth of 15 RBs using subcarrier spacing of 15 kHz, a synchronization signal block (SSB) puncturing pattern 505A-B to reduce the number of resource blocks (RBs) from legacy 20-RB SSB to a 12-RB SSB may include puncturing the first four RBs (RBs 0-3) and the last four RBs (RBs 16-19) of every PBCH symbol. In some aspects, a first puncturing pattern 510A for CORESET (e.g., CORESET0 indicated by a PBCH/MIB) to reduce the number of RBs from a legacy 24-RB CORESET to a 15-RB CORESET may include applying offset of 0 RB between the legacy 24-RB CORESET and the legacy 20-RB SSB without puncturing. As shown in the example 500, the first three RBs (RBs 0-2) and the last 6 RBs (RBs 18-23) of the first puncturing pattern 510A are punctured in every CORESET symbol. With an offset of 0, the puncturing pattern may be predefined as puncturing 3 RBs at lower frequencies and 6 RBs at higher frequencies. Therefore, with an offset of ORB between a lowest RB of the legacy CORESET without puncturing relative to the lowest RB of legacy SSB without puncturing, the 12-RB SSB (RBs 4-15) after puncturing and 15-RB CORESET (RBs 3-17) after puncturing are both transmitted within the 3 MHz channel bandwidth. With an offset, such as an offset of 2 RBs between legacy 24-RB CORESET and the legacy 20-RB SSB without puncturing shown in the example 500, the first puncturing pattern 510B for CORESET may be predefined as puncturing 6 RBs at lower frequencies and 3 RBs at higher frequencies in every CORESET symbol. Therefore, with an offset of 2 RBs between the lowest RB of the legacy CORESET without puncturing relative to the lowest RB of legacy SSB without puncturing, the 12-RB SSB (RBs 4-15) after puncturing and 15-RB CORESET (RBs 6-20) after puncturing are both transmitted within the 3 MHz channel bandwidth in every CORESET symbol. Regardless of the offset, in some aspects, such as when the REG bundle size is a 6, partial CCEs may be punctured at higher frequencies or lower frequencies. For example, according to the first puncturing pattern 510A, the first 3 RBs (RBs 0-2) and the last 6 RBs (RBs 18-23) of the legacy 24-RB CORESET are punctured respectively, resulting in 1.5 CCEs and 3 CCEs punctured in lower and higher frequency in the case of a 3-symbol CORSET, where each CCE has 6 RBs in total with 2 RBs in the frequency domain and 3 symbols in the time domain. Similarly, according to the first puncturing pattern 510B, the first 6 RBs (RBs 0-5) and the last 3 RBs (RBs 21-23) of the legacy 24-RB CORESET are punctured respectively, resulting in 3 CCEs and 1.5 CCEs punctured in lower and higher frequency in case of 3-symbol CORESET. On the other hand, if the first 4 RBs (RBs 0-3) and the last 5 RBs (RBs 19-23) of the legacy 24-RB CORESET are punctured respectively, resulting in 2 CCEs and 2.5 CCEs punctured in case of 3-symbol CORESET but 1.3 CCEs and 2.6 CCEs punctured in lower and higher frequency in case of 2-symbol CORSET, where each CCE has 6 RBGs bundled together with 3 RBs in the frequency domain and 2 symbols in the time domain. In order to minimize the partial CCE puncturing, at least one of puncturing an RB number in a lower or higher frequency should be a multiple of RBG-bundle size 6.

In a second puncturing pattern 515A-B, the RB offset, if any, may be relative to the 12-RB SSB after puncturing with the puncturing pattern 505A-B. For example, as shown in the second puncturing pattern 515A-B, no RBs are punctured at the lower frequencies, which leaves 9 RBs (RBs 15-23) to be punctured at the higher frequencies. In the second puncturing pattern 515A-B, partial CCEs may be punctured at the higher frequencies depending on the number of RBs in an REG bundle and the number of RBs to be punctured. Further, as shown in the example 500, the second puncturing pattern 515B may have an offset of 2 relative to the 12-RB SSB after puncturing with puncturing pattern 505B. Thereafter, with an offset of 0 or 2 RBs between lowest RB of the legacy CORESET before puncturing relative to lowest RB of the SSB after puncturing, the 12-RB SSB (RBs 4-15) after puncturing and 15-RB CORESET (RBs 0-14) after puncturing are both transmitted within the 3 MHz channel bandwidth in every CORESET symbol.

In some aspects, the offset for the puncturing pattern may be zero RBs (e.g., the SSB puncturing pattern 505A or the CORESET puncturing pattern 510A) or 2 RBs (e.g., the SSB puncturing pattern 505B or the CORESET puncturing pattern 510B) for a CORESET with 15 RBs punctured from a 24 RB legacy CORESET. Other offsets may be possible so long as the CORESET and SSB are within a max bandwidth relative to the number of RBs and the channel bandwidth. For example, an offset of 4 may not be applicable for 15 RBs with a 3 MHz channel bandwidth, because the SSB and CORESET cannot be transmitted together within a 3 MHz channel bandwidth.

As indicated above, FIG. 5 is provided as an example. Other examples may differ from what is described with respect to FIG. 5.

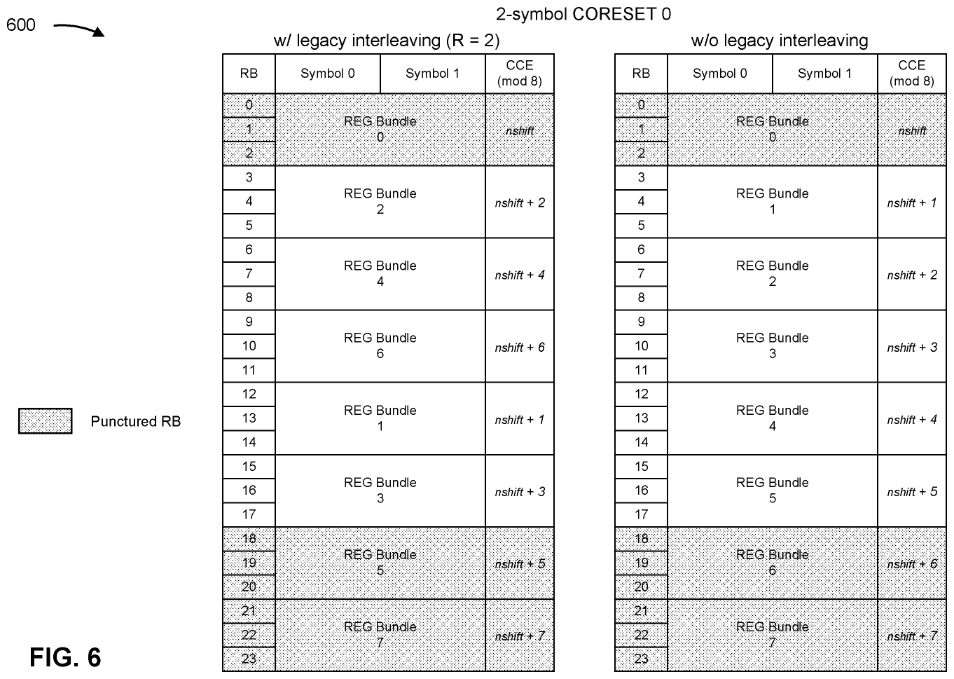

FIGS. 6-11 are diagrams illustrating examples 600-1100 associated with different CORESET puncturing patterns, in accordance with the present disclosure.

The example 600 of FIG. 6 illustrates a two-symbol CORESET. Each REG bundle includes 6 REGs bundled together with three RBs in the frequency domain and 2 symbols in the time domain, and the example 600 shows a total of eight REG bundles in the legacy 24-RB CORESET. A CCE shift (shown as n_{shift}) is shown for each REG bundle. Moreover, the example 600 illustrates one option with interleaving (e.g., interleaver size of 2) and one option without interleaving. In the example 600, the puncturing pattern may be defined as puncturing 3 RBs at lower frequencies and 6 RBs at higher frequencies in every CORESET symbol. There are no partial CCEs punctured at both lower and higher frequencies. Accordingly, as shown, RBs 0-2 and 18-23 are punctured in the options shown in example 600.

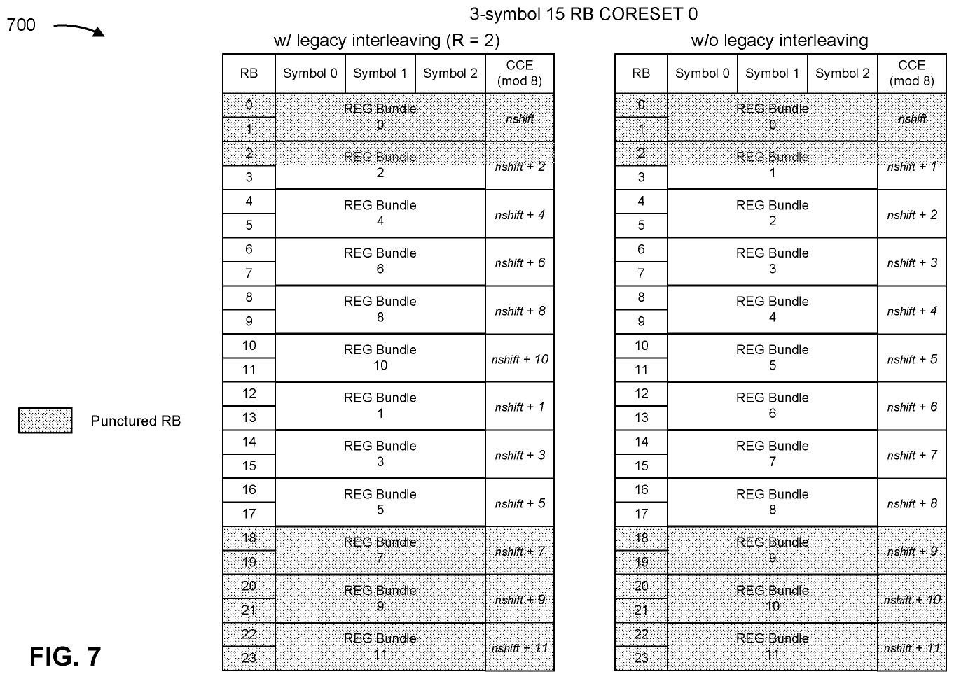

The example 700 of FIG. 7 illustrates a three-symbol CORESET. Each REG bundle includes 6 REGs bundled together with two RBs in the frequency domain and 3 symbols in the time domain, and the example 700 shows a total of 12 REG bundles in the legacy 24-RB CORESET. A CCE shift is shown for each REG bundle. Moreover, the example 700 illustrates one option with interleaving (e.g., interleaver size of 2) and one option without interleaving. Like the example 600, in the example 700, the puncturing pattern may be defined as puncturing 3 RBs at lower frequencies and 6 RBs at higher frequencies in every CORESET symbol. There is one partial CCE punctured at lower frequency but no partial CCEs punctured at higher frequency. Accordingly, as shown, RBs 0-2 and 18-23 are punctured in the options shown in example 700, which results in partial CCE puncturing with respect to REG bundle 2 (with interleaving) or REG bundle 1 (without interleaving), which both include punctured RB 2.

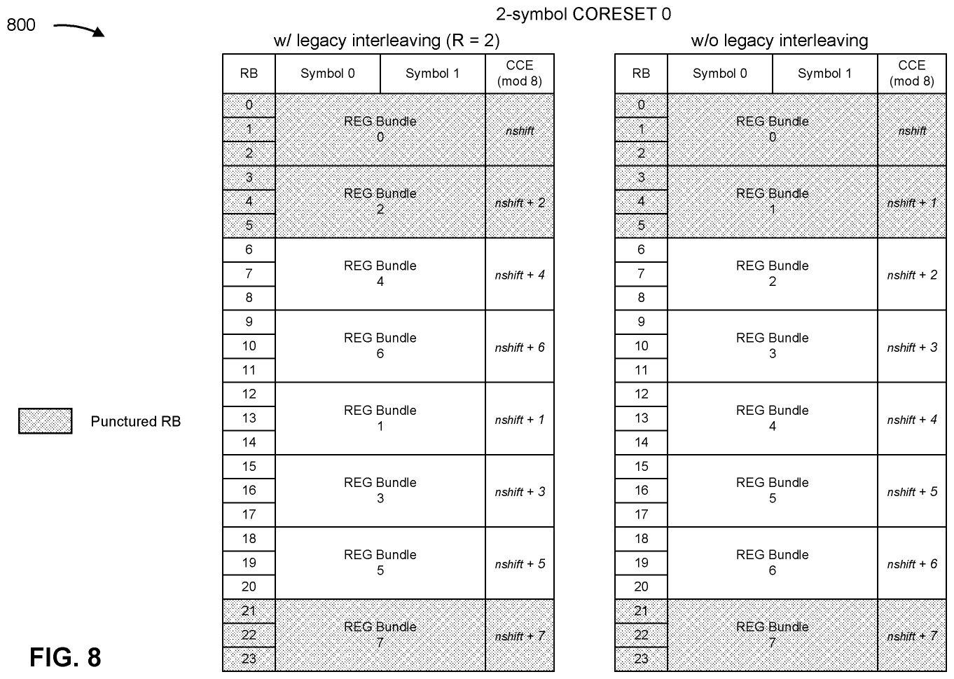

The example 800 of FIG. 8 illustrates a two-symbol CORESET. Each REG bundle includes 6 REGs bundled together with three RBs in the frequency domain and 2 symbols in the time domain, and the example 800 shows a total of eight REG bundles in the legacy 24-RB CORESET. A CCE shift is shown for each REG bundle. Moreover, the example 800 illustrates one option with interleaving (e.g., interleaver size of 2) and one option without interleaving. In the example 800, the puncturing pattern may be defined as puncturing 6 RBs at lower frequencies and 3 RBs at higher frequencies in every CORESET symbol. Partial CCEs may be punctured at higher frequencies. There are no partial CCEs punctured at both the lower and higher frequencies. Accordingly, as shown, RBs 0-5 and 21-23 are punctured in the options shown in example 800.

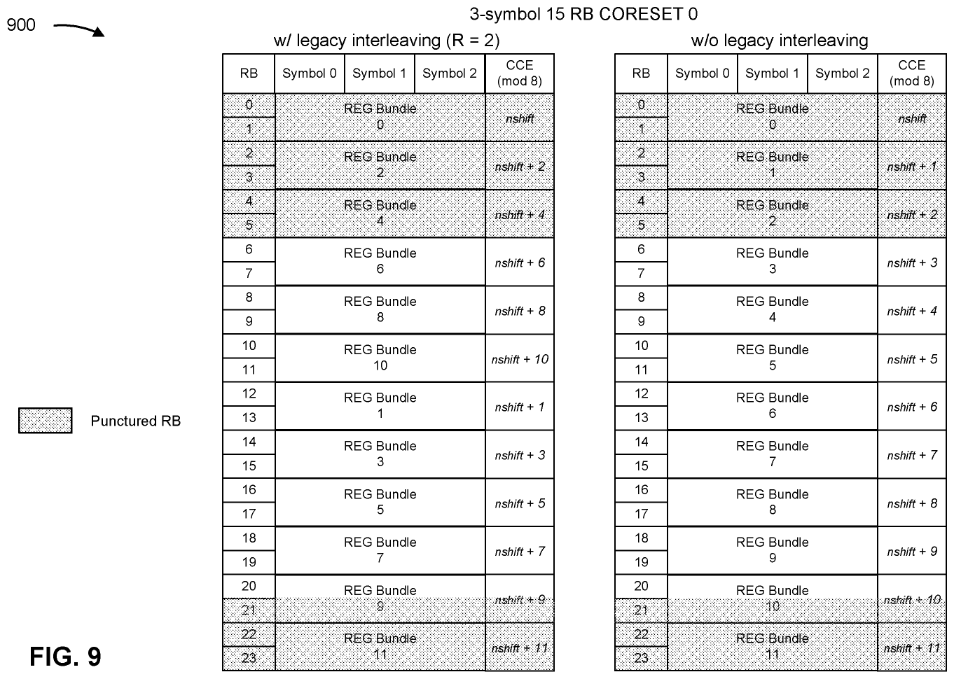

The example 900 of FIG. 9 illustrates a three-symbol CORESET. Each REG bundle includes 6 REGs bundled together with two RBs in the frequency domain and 3 symbols in the time domain, and the example 900 shows a total of 12 REG bundles in the legacy 24-RB CORESET. A CCE shift is shown for each REG bundle. Moreover, the example 900 illustrates one option with interleaving (e.g., interleaver size of 2) and one option without interleaving. Like the example 800, in the example 900, the puncturing pattern may be defined as puncturing 6 RBs at lower frequencies and 3 RBs at higher frequencies. Partial CCEs may be punctured at higher frequencies. There is one partial CCE punctured at the higher frequency but no partial CCEs punctured at the lower frequency. Accordingly, as shown, RBs 0-5 and 21-23 are punctured in the options shown in example 900, which results in partial CCE puncturing with respect to REG bundle 9 (with interleaving) or REG bundle 10 (without interleaving), both of which include the punctured RB 21.

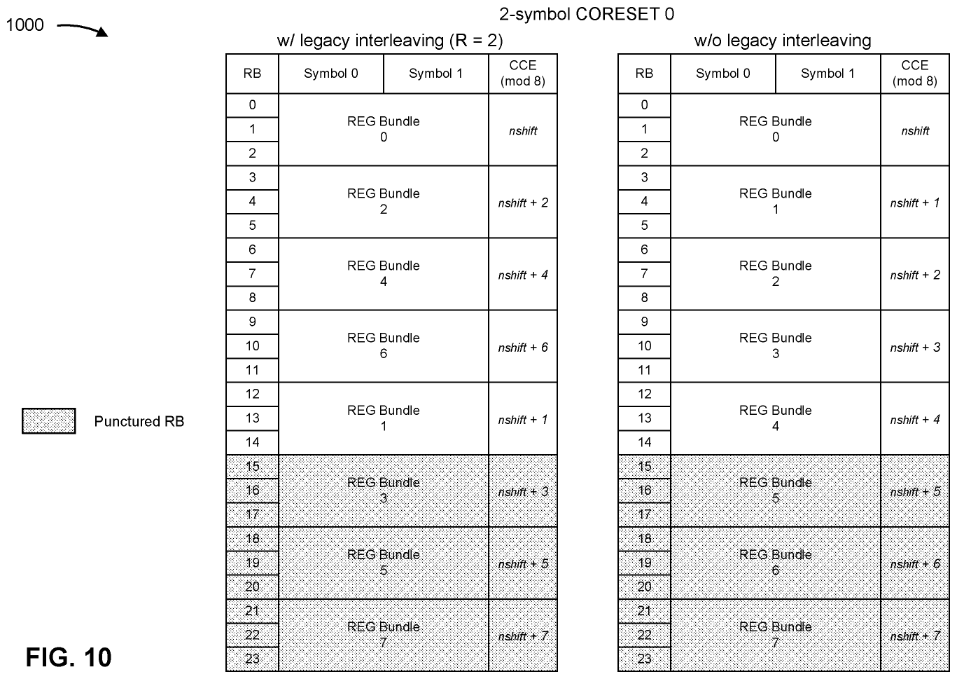

The example 1000 of FIG. 10 illustrates a two-symbol CORESET. Each REG bundle includes 6 REGs bundled together with three RBs in the frequency domain and 2 symbols in the time domain, and the example 1000 shows a total of eight REG bundles in the legacy 24-RB CORESET. A CCE shift is shown for each REG bundle.

Moreover, the example 1000 illustrates one option with interleaving (e.g., interleaver size of 2) and one option without interleaving. In the example 1000, the puncturing pattern may be defined as puncturing 9 RBs at higher frequencies. There are no partial CCE punctured at both higher and lower frequencies. Accordingly, as shown, RBs 15-23 are punctured in the options shown in example 1000.

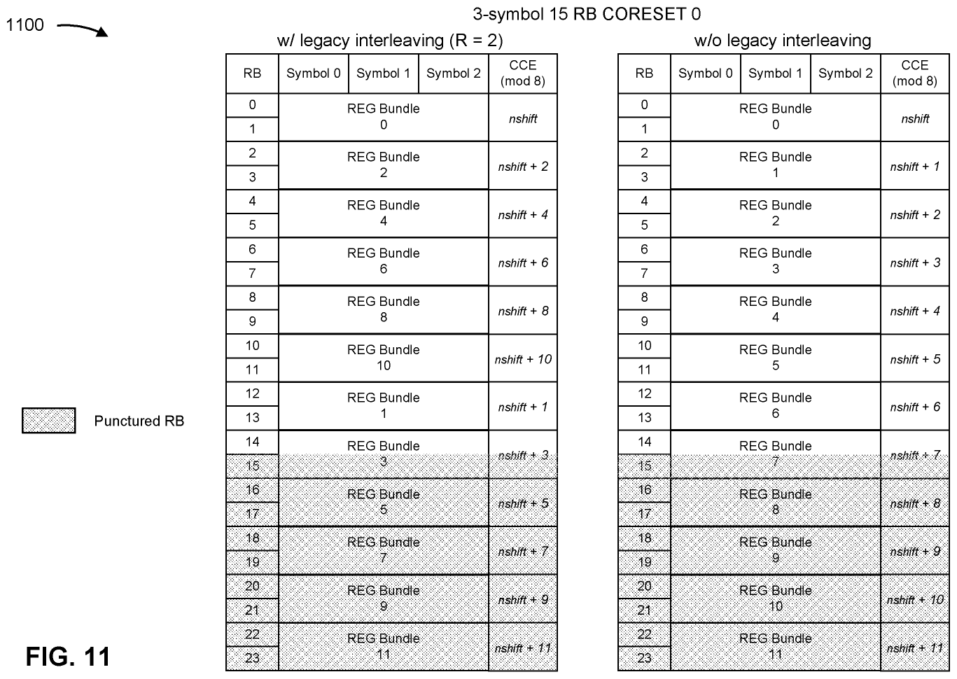

The example 1100 of FIG. 11 illustrates a three-symbol CORESET. Each REG bundle includes 6 REGs bundled together with two RBs in the frequency domain and 3 symbols in the time domain, and the example 1100 shows a total of 12 REG bundles in the legacy 24-RB CORESET. A CCE shift is shown for each REG bundle. Moreover, the example 1100 illustrates one option with interleaving (e.g., interleaver size of 2) and one option without interleaving. Like the example 1000, in the example 1100, the puncturing pattern may be defined as puncturing 9 RBs at higher frequencies. There is only one partial CCE punctured at a higher frequency and no partial CCEs at a lower frequency. Accordingly, as shown, RBs 15-23 are punctured in the options shown in example 1100, which results in one partial CCE puncturing with respect to REG bundle 3 (with interleaving) or REG bundle 7 (without interleaving), both of which include punctured RB 15.

For legacy CORESETs, a CCE shift may be a cell identifier used for CCE-to-REG mapping. For CORESETs punctured from, e.g., a legacy 24-RB CORESET to a 15-RB CORESET, a large aggregation level (such as an aggregation level of 8) may not be supported for a CORESET with 15 RBs in certain circumstances, such as if more than two CCEs are punctured, there is a minimal performance gain than smaller AL, e.g., AL of 4, due to puncturing. In the case of a 2-symbol CORESET, more than two CCEs among a legacy 8 CCEs of legacy 24-RB CORESET are punctured with or without interleaving. In the case of a 3-symbol CORESET, more than two CCEs among a legacy 12 CCEs of legacy 24-RB CORESET may be punctured if the puncturing is with interleaving and for an aggregation level of 8. Without interleaving, fewer than two CCEs are punctured for an aggregation level of 8 when the CCE shift is equal to 0, 1, or 2. Otherwise, more than two CCEs are punctured if the aggregation level is 8.

In some aspects, to achieve a desired aggregation level, the CCE-to-REG mapping of the CORESET may be modified based, at least in part, on a CORESET puncturing pattern and configuration parameters for a particular channel bandwidth, such as a 3 MHz channel bandwidth. For a CORESET with 15 RBs, 3 symbols, and no interleaving, the CCE shift may be equal to a variable Y plus the cell identifier mod X. The value for X may be a constant such as, e.g., 3, which may be based, at least in part, on cell randomization and the number of punctured CCEs for a desired aggregation level (e.g., 8). The variable Y may be the number of the CORESET CCEs (before puncturing) minus the number of RBs to be punctured in the lower frequencies. The variable Y may also be equal to the result of the total number of RBs (e.g., 24 RBs) minus the number of RBs to be punctured in the lower frequencies multiplied by the number of symbols for the CORESET and divided by the REG bundle size L. An example equation for Y is shown below.

$$Y = {N}_{CCE}^{CORESET} - {N}_{CCE \_ punctured}^{CORRESET} = ⌊ \frac{( 24 - {N}_{RB \_ punctured}^{CORESET} ) {N}_{symbol}^{CORESET}}{L} ⌋$$

In another example, such as for a 20-RB CORESET associated with a 5 MHz channel bandwidth, if four RBs are to be punctured from the legacy 24-RB CORESET, there may be up to two CCEs to be punctured and the CCE shift may be equal to the cell identifier. In another example, such as for a CORESET associated with a 3 MHz channel bandwidth, if there are no RBs to be punctured (i.e., CCE-to-REG mapping is directly based on the indicated number of RBs for every symbol of the CORESET), the CCE shift may be equal to the cell identifier.

As indicated above, FIGS. 6-11 are provided as examples. Other examples may differ from what is described with respect to FIGS. 6-11.

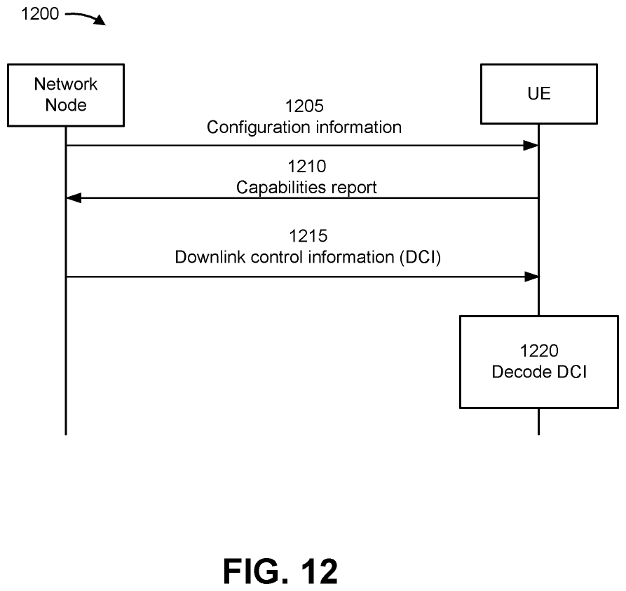

FIG. 12 is a diagram of an example 1200 associated with decoding DCI signals, in accordance with the present disclosure. As shown in FIG. 12, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 12.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the UE is to receive signaling identifying a CORESET puncturing pattern. As discussed above, the CORESET puncturing pattern may be based, at least in part, on the number of RBs available before and after a CORESET puncturing process and on the number of symbols of the CORESET.

The UE may configure itself based at least in part on the configuration information. In some aspects, the UE may be configured to perform one or more operations described herein based at least in part on the configuration information.

As shown by reference number 1210, the UE may transmit, and the network node may receive, a capabilities report. The capabilities report may indicate whether the UE supports a feature and/or one or more parameters related to the feature. For example, the capability information may indicate a capability and/or parameter for CORESET puncturing. As another example, the capabilities report may indicate a capability and/or parameter for decoding DCI signals in accordance with the CORESET puncturing. One or more operations described herein may be based on capability information of the capabilities report. For example, the UE may perform a communication in accordance with the capability information, or may receive configuration information that is in accordance with the capability information. In some aspects, the capabilities report may indicate UE support for applying a CORESET puncturing pattern, CCE-to-REG mapping, modifying CCE shifts, and decoding DCI according to the CORESET puncturing pattern, CCE-to-REG mapping, and modified CCE shifts.

In some aspects, the configuration information described in connection with reference number 1205 and/or the capabilities report may include information transmitted via multiple communications. Additionally, or alternatively, the network node may transmit the configuration information, or a communication including at least a portion of the configuration information, before and/or after the UE transmits the capabilities report. For example, the network node may transmit a first portion of the configuration information before the capabilities report, the UE may transmit at least a portion of the capabilities report, and the network node may transmit a second portion of the configuration information after receiving the capabilities report.

As shown by reference number 1215, the UE may receive, and the network node may transmit, downlink control information in accordance with the CORESET puncturing pattern.

As shown by reference number 1220, the UE may configure itself, based at least in part on receiving the indication described in connection with reference number 1215, to decode the DCI.

As indicated above, FIG. 12 is provided as an example. Other examples may differ from what is described with respect to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with CORESET puncturing.

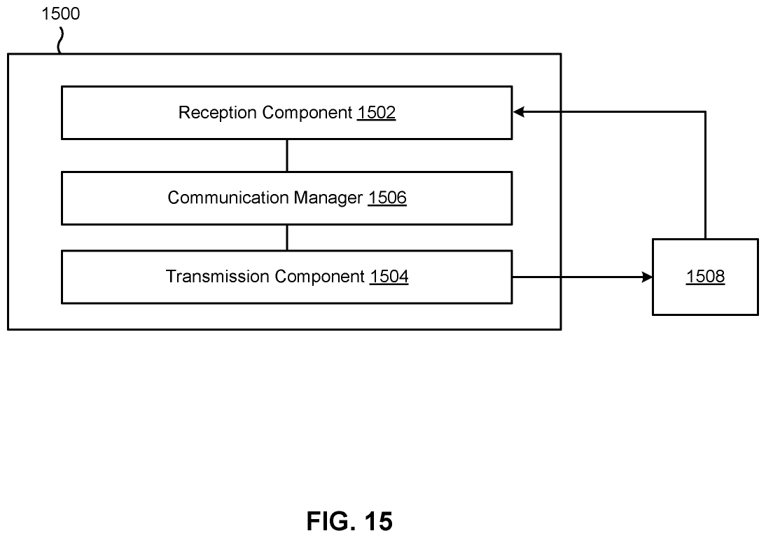

As shown in FIG. 13, in some aspects, process 1300 may include receiving signaling identifying a CORESET puncturing pattern, the CORESET puncturing pattern being based, at least in part, on a number of resource blocks available before and after a CORESET puncturing process and a number of symbols of the CORESET (block 1310). For example, the UE (e.g., using communication manager 1506, depicted in FIG. 15) may receive signaling identifying a CORESET puncturing pattern, the CORESET puncturing pattern being based, at least in part, on a number of resource blocks available before and after a CORESET puncturing process and a number of symbols of the CORESET, as described above.

As further shown in FIG. 13, in some aspects, process 1300 may include decoding downlink control information in accordance with the CORESET puncturing pattern (block 1320). For example, the UE (e.g., using communication manager 1506, depicted in FIG. 15) may decode downlink control information in accordance with the CORESET puncturing pattern, as described above.

Process 1300 may include additional aspects, such as any single aspect or any combination of aspects described below and/or in connection with one or more other processes described elsewhere herein.

In a first aspect, the CORESET puncturing pattern is further based, at least in part, on a resource block offset between a starting resource block of the CORESET before the CORESET puncturing process and a starting resource block of a SSB communication after the CORESET puncturing process.

In a second aspect, alone or in combination with the first aspect, the CORESET puncturing pattern includes puncturing a first number of resource blocks at a first frequency or a second number of resource blocks at a second frequency.

In a third aspect, alone or in combination with one or more of the first and second aspects, the CORESET puncturing pattern includes partial puncturing of a single CCE.

In a fourth aspect, alone or in combination with one or more of the first through third aspects, the partial puncturing of the single CCE occurs with respect to resource blocks associated with the first frequency or resource blocks associated with the second frequency.

In a fifth aspect, alone or in combination with one or more of the first through fourth aspects, the CORESET puncturing pattern is based, at least in part, on a REG bundle size.

In a sixth aspect, alone or in combination with one or more of the first through fifth aspects, process 1300 includes determining, based, at least in part, on signaling identifying the CORESET, a CCE-to-REG mapping associated with the CORESET puncturing pattern.

In a seventh aspect, alone or in combination with one or more of the first through sixth aspects, an aggregation level is based, at least in part, on the CORESET puncturing pattern and the CCE-to-REG mapping.

In an eighth aspect, alone or in combination with one or more of the first through seventh aspects, the CCE-to-REG mapping is based, at least in part, on a CCE shift.

In a ninth aspect, alone or in combination with one or more of the first through eighth aspects, the CCE shift for the CCE-to-REG mapping is based, at least in part, on a cell identifier and a maximum number of CCEs to be punctured for an aggregation level.

In a tenth aspect, alone or in combination with one or more of the first through ninth aspects, the CCE shift for the CCE-to-REG mapping is based, at least in part, on a number of CCEs associated with the CORESET before puncturing and a number of CCEs to be punctured in a first frequency.

In an eleventh aspect, alone or in combination with one or more of the first through tenth aspects, the CCE shift is based, at least in part, on a number of resource blocks associated with the CORESET after puncturing, or on a number of symbols associated with the CORESET.

In a twelfth aspect, alone or in combination with one or more of the first through eleventh aspects, the CCE shift is based, at least in part, on whether REG-bundles for the CORESET are interleaved.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with CORESET puncturing.

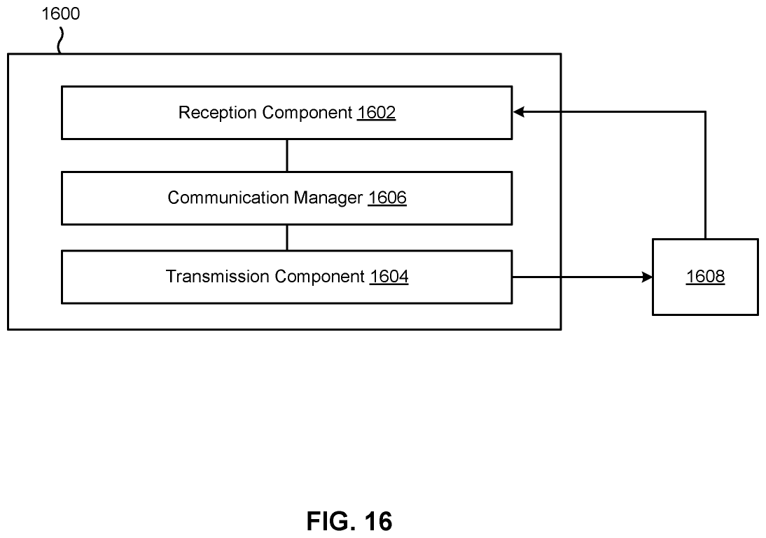

As shown in FIG. 14, in some aspects, process 1400 may include outputting signaling identifying a CORESET puncturing pattern, the CORESET puncturing pattern being based, at least in part, on a number of resource blocks available before and after a CORESET puncturing process and a number of symbols of the CORESET (block 1410). For example, the network node (e.g., using transmission component 1604 and/or communication manager 1606, depicted in FIG. 16) may output signaling identifying a CORESET puncturing pattern, the CORESET puncturing pattern being based, at least in part, on a number of resource blocks available before and after a CORESET puncturing process and a number of symbols of the CORESET, as described above.

As further shown in FIG. 14, in some aspects, process 1400 may include configuring a UE to decode downlink control information in accordance with the CORESET puncturing pattern (block 1420). For example, the network node (e.g., using communication manager 1606, depicted in FIG. 16) may configure a UE to decode downlink control information in accordance with the CORESET puncturing pattern, as described above.

Process 1400 may include additional aspects, such as any single aspect or any combination of aspects described below and/or in connection with one or more other processes described elsewhere herein.

In a first aspect, the CORESET puncturing pattern is further based, at least in part, on a resource block offset between a starting resource block of the CORESET before the CORESET puncturing process and a starting resource block of a SSB communication after the CORESET puncturing process.

In a second aspect, alone or in combination with the first aspect, the CORESET puncturing pattern includes puncturing a first number of resource blocks at a first frequency or a second number of resource blocks at a second frequency.

In a third aspect, alone or in combination with one or more of the first and second aspects, the CORESET puncturing pattern includes partial puncturing of a single CCE.

In a fourth aspect, alone or in combination with one or more of the first through third aspects, the partial puncturing of the single CCE occurs with respect to resource blocks associated with the first frequency or resource blocks associated with the second frequency.

In a fifth aspect, alone or in combination with one or more of the first through fourth aspects, the CORESET puncturing pattern is based, at least in part, on a REG bundle size.

In a sixth aspect, alone or in combination with one or more of the first through fifth aspects, process 1400 includes configuring the UE to determine, based, at least in part, on signaling identifying the CORESET, a CCE-to-REG mapping associated with the CORESET puncturing pattern.

In a seventh aspect, alone or in combination with one or more of the first through sixth aspects, an aggregation level is based, at least in part, on the CORESET puncturing pattern and the CCE-to-REG mapping.

In an eighth aspect, alone or in combination with one or more of the first through seventh aspects, the CCE-to-REG mapping is based, at least in part, on a CCE shift.

In a ninth aspect, alone or in combination with one or more of the first through eighth aspects, the CCE shift for the CCE-to-REG mapping is based, at least in part, on a cell identifier and a maximum number of CCEs to be punctured for an aggregation level.

In a tenth aspect, alone or in combination with one or more of the first through ninth aspects, the CCE shift for the CCE-to-REG mapping is based, at least in part, on a number of CCEs associated with the CORESET before puncturing and a number of CCEs to be punctured in a first frequency.

In an eleventh aspect, alone or in combination with one or more of the first through tenth aspects, the CCE shift is based, at least in part, on a number of resource blocks associated with the CORESET after puncturing, or on a number of symbols associated with the CORESET.

In a twelfth aspect, alone or in combination with one or more of the first through eleventh aspects, the CCE shift is based, at least in part, on whether REG-bundles for the CORESET are interleaved.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 4-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The communication manager 1506 may receive signaling identifying a CORESET puncturing pattern, the CORESET puncturing pattern being based, at least in part, on a number of resource blocks available before and after a CORESET puncturing process and a number of symbols of the CORESET. The communication manager 1506 may decode downlink control information in accordance with the CORESET puncturing pattern.

The communication manager 1506 may determine, based, at least in part, on signaling identifying the CORESET, a CCE-to-REG mapping associated with the CORESET puncturing pattern.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 4-11. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The transmission component 1604 may output signaling identifying a CORESET puncturing pattern, the CORESET puncturing pattern being based, at least in part, on a number of resource blocks available before and after a CORESET puncturing process and a number of symbols of the CORESET. The communication manager 1606 may configure a UE to decode downlink control information in accordance with the CORESET puncturing pattern.

The communication manager 1606 may configure the UE to determine, based, at least in part, on signaling identifying the CORESET, a CCE-to-REG mapping associated with the CORESET puncturing pattern.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a UE, comprising: receiving signaling identifying a CORESET puncturing pattern, the CORESET puncturing pattern being based, at least in part, on a number of resource blocks available before and after a CORESET puncturing process and a number of symbols of the CORESET; and decoding downlink control information in accordance with the CORESET puncturing pattern.
Aspect 2: The method of Aspect 1, wherein the CORESET puncturing pattern is further based, at least in part, on a resource block offset between a starting resource block of the CORESET before the CORESET puncturing process and a starting resource block of a SSB communication after the CORESET puncturing process.
Aspect 3: The method of any of Aspects 1-2, wherein the CORESET puncturing pattern includes puncturing a first number of resource blocks at a first frequency or a second number of resource blocks at a second frequency.
Aspect 4: The method of Aspect 3, wherein the CORESET puncturing pattern includes partial puncturing of a single CCE.
Aspect 5: The method of Aspect 4, wherein the partial puncturing of the single CCE occurs with respect to resource blocks associated with the first frequency or resource blocks associated with the second frequency.
Aspect 6: The method of any of Aspects 1-5, wherein the CORESET puncturing pattern is based, at least in part, on a REG bundle size.
Aspect 7: The method of any of Aspects 1-6, further comprising determine, based, at least in part, on signaling identifying the CORESET, a CCE-to-REG mapping associated with the CORESET puncturing pattern.
Aspect 8: The method of Aspect 7, wherein an aggregation level is based, at least in part, on the CORESET puncturing pattern and the CCE-to-REG mapping.
Aspect 9: The method of Aspect 7, wherein the CCE-to-REG mapping is based, at least in part, on a CCE shift.
Aspect 10: The method of Aspect 9, wherein the CCE shift for the CCE-to-REG mapping is based, at least in part, on a cell identifier and a maximum number of CCEs to be punctured for an aggregation level.
Aspect 11: The method of Aspect 9, wherein the CCE shift for the CCE-to-REG mapping is based, at least in part, on a number of CCEs associated with the CORESET before puncturing and a number of CCEs to be punctured in a first frequency.
Aspect 12: The method of Aspect 11, wherein the CCE shift is based, at least in part, on a number of resource blocks associated with the CORESET after puncturing, or on a number of symbols associated with the CORESET.
Aspect 13: The method of Aspect 11, wherein the CCE shift is based, at least in part, on whether REG-bundles for the CORESET are interleaved.
Aspect 14: The method of any of Aspects 1-14, wherein the CORESET is a CORESET0.
Aspect 15: A method of wireless communication performed by a network node, comprising: outputting signaling identifying a CORESET puncturing pattern, the CORESET puncturing pattern being based, at least in part, on a number of resource blocks available before and after a CORESET puncturing process and a number of symbols of the CORESET; and configuring a UE to decode downlink control information in accordance with the CORESET puncturing pattern.
Aspect 16: The method of Aspect 15, wherein the CORESET puncturing pattern is further based, at least in part, on a resource block offset between a starting resource block of the CORESET before the CORESET puncturing process and a starting resource block of a SSB communication after the CORESET puncturing process.
Aspect 17: The method of any of Aspects 15-16, wherein the CORESET puncturing pattern includes puncturing a first number of resource blocks at a first frequency or a second number of resource blocks at a second frequency.
Aspect 18: The method of Aspect 17, wherein the CORESET puncturing pattern includes partial puncturing of a single CCE.
Aspect 19: The method of Aspect 18, wherein the partial puncturing of the single CCE occurs with respect to resource blocks associated with the first frequency or resource blocks associated with the second frequency.
Aspect 20: The method of any of Aspects 15-19, wherein the CORESET puncturing pattern is based, at least in part, on a REG bundle size.
Aspect 21: The method of any of Aspects 15-20, further comprising configuring the UE to determine, based, at least in part, on signaling identifying the CORESET, a CCE-to-REG mapping associated with the CORESET puncturing pattern.
Aspect 22: The method of Aspect 21, wherein an aggregation level is based, at least in part, on the CORESET puncturing pattern and the CCE-to-REG mapping.
Aspect 23: The method of Aspect 21, wherein the CCE-to-REG mapping is based, at least in part, on a CCE shift.
Aspect 24: The method of Aspect 23, wherein the CCE shift for the CCE-to-REG mapping is based, at least in part, on a cell identifier and a maximum number of CCEs to be punctured for an aggregation level.
Aspect 25: The method of Aspect 23, wherein the CCE shift for the CCE-to-REG mapping is based, at least in part, on a number of CCEs associated with the CORESET before puncturing and a number of CCEs to be punctured in a first frequency.
Aspect 26: The method of Aspect 25, wherein the CCE shift is based, at least in part, on a number of resource blocks associated with the CORESET after puncturing, or on a number of symbols associated with the CORESET.
Aspect 27: The method of Aspect 25, wherein the CCE shift is based, at least in part, on whether REG-bundles for the CORESET are interleaved.
Aspect 28: The method of any of Aspects 15-27, wherein the CORESET is a CORESET0.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.
Aspect 32: A non-transitory computer-readable medium storing code for wireless communication, the code comprising instructions executable by one or more processors to individually or collectively perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, individually or collectively configured to cause the UE to:
receive signaling identifying a control resource set (CORESET) puncturing pattern, the CORESET puncturing pattern being based, at least in part, on a number of resource blocks available before and after a CORESET puncturing process and a number of symbols of the CORESET; and
decode downlink control information in accordance with the CORESET puncturing pattern.

2. The UE of claim 1, wherein the CORESET puncturing pattern is further based, at least in part, on a resource block offset between a starting resource block of the CORESET before the CORESET puncturing process and a starting resource block of a synchronization signal block (SSB) communication after the CORESET puncturing process.

3. The UE of claim 1, wherein the CORESET puncturing pattern includes puncturing a first number of resource blocks at a first frequency or a second number of resource blocks at a second frequency.

4. The UE of claim 3, wherein the CORESET puncturing pattern includes partial puncturing of a single control channel element (CCE).

5. The UE of claim 4, wherein the partial puncturing of the single CCE occurs with respect to resource blocks associated with the first frequency or resource blocks associated with the second frequency.

6. The UE of claim 1, wherein the CORESET puncturing pattern is based, at least in part, on a resource element group (REG) bundle size.

7. The UE of claim 1, wherein the one or more processors are further individually or collectively configured to cause the UE to determine, based, at least in part, on signaling identifying the CORESET, a control channel element (CCE)-to-resource element group (REG) mapping associated with the CORESET puncturing pattern.

8. The UE of claim 7, wherein an aggregation level is based, at least in part, on the CORESET puncturing pattern and the CCE-to-REG mapping.

9. The UE of claim 7, wherein the CCE-to-REG mapping is based, at least in part, on a CCE shift.

10. The UE of claim 9, wherein the CCE shift for the CCE-to-REG mapping is based, at least in part, on a cell identifier and a maximum number of CCEs to be punctured for an aggregation level.

11. The UE of claim 9, wherein the CCE shift for the CCE-to-REG mapping is based, at least in part, on a number of CCEs associated with the CORESET before puncturing and a number of CCEs to be punctured in a first frequency.

12. The UE of claim 11, wherein the CCE shift is based, at least in part, on a number of resource blocks associated with the CORESET after puncturing, or on a number of symbols associated with the CORESET.

13. The UE of claim 11, wherein the CCE shift is based, at least in part, on whether REG-bundles for the CORESET are interleaved.

14. The UE of claim 1, wherein the CORESET is CORESET0.

15. A network node for wireless communication, comprising:
one or more memories; and
one or more processors, coupled to the one or more memories, individually or collectively configured to cause the network node to:
output signaling identifying a control resource set (CORESET) puncturing pattern, the CORESET puncturing pattern being based, at least in part, on a number of resource blocks available before and after a CORESET puncturing process and a number of symbols of the CORESET; and
configure a user equipment (UE) to decode downlink control information in accordance with the CORESET puncturing pattern.

16. The network node of claim 15, wherein the CORESET puncturing pattern is further based, at least in part, on a resource block offset between a starting resource block of the CORESET before the CORESET puncturing process and a starting resource block of a synchronization signal block (SSB) communication after the CORESET puncturing process.

17. The network node of claim 15, wherein the CORESET puncturing pattern includes puncturing a first number of resource blocks at a first frequency or a second number of resource blocks at a second frequency.

18. The network node of claim 17, wherein the CORESET puncturing pattern includes partial puncturing of a single control channel element (CCE).

19. The network node of claim 18, wherein the partial puncturing of the single CCE occurs with respect to resource blocks associated with the first frequency or resource blocks associated with the second frequency.

20. The network node of claim 15, wherein the CORESET puncturing pattern is based, at least in part, on a resource element group (REG) bundle size.

21. The network node of claim 15, wherein the one or more processors are further individually or collectively configured to cause the network node to configure the UE to determine, based, at least in part, on signaling identifying the CORESET, a control channel element (CCE)-to-resource element group (REG) mapping associated with the CORESET puncturing pattern.

22. The network node of claim 21, wherein an aggregation level is based, at least in part, on the CORESET puncturing pattern and the CCE-to-REG mapping.

23. The network node of claim 21, wherein the CCE-to-REG mapping is based, at least in part, on a CCE shift.

24. The network node of claim 23, wherein the CCE shift for the CCE-to-REG mapping is based, at least in part, on a cell identifier and a maximum number of CCEs to be punctured for an aggregation level.

25. The network node of claim 23, wherein the CCE shift for the CCE-to-REG mapping is based, at least in part, on a number of CCEs associated with the CORESET before puncturing and a number of CCEs to be punctured in a first frequency.

26. The network node of claim 25, wherein the CCE shift is based, at least in part, on a number of resource blocks associated with the CORESET after puncturing, or on a number of symbols associated with the CORESET.

27. The network node of claim 25, wherein the CCE shift is based, at least in part, on whether REG-bundles for the CORESET are interleaved.

28. The network node of claim 15, wherein the CORESET is CORESET0.

29. A method of wireless communication performed by a user equipment (UE), comprising:
receiving signaling identifying a control resource set (CORESET) puncturing pattern, the CORESET puncturing pattern being based, at least in part, on a number of resource blocks available before and after a CORESET puncturing process and a number of symbols of the CORESET; and
decoding downlink control information in accordance with the CORESET puncturing pattern.

30. A method of wireless communication performed by a network node, comprising:
outputting signaling identifying a control resource set (CORESET) puncturing pattern, the CORESET puncturing pattern being based, at least in part, on a number of resource blocks available before and after a CORESET puncturing process and a number of symbols of the CORESET; and
configuring a user equipment (UE) to decode downlink control information in accordance with the CORESET puncturing pattern.
